(19) United States
(12) Patent Application Publication
(10) Pub. No.: US 2024/0353286 A1
(43) Pub. Date: Oct. 24, 2024

(54) SYSTEMS AND METHODS FOR DETECTING OBJECT RESONANCE CAUSED BY VORTEX SHEDDING

(71) Applicant: HERC BUILD LLC, Bonita Springs, FL (US)

(72) Inventors: Brian DWIGHT, Lindsay (CA); Craig PRATT, Whitchurch-Stouffville (CA); David DWIGHT, Pickering (CA)

(21) Appl. No.: 18/640,603

(22) Filed: Apr. 19, 2024

Related U.S. Application Data
(60) Provisional application No. 63/461,187, filed on Apr. 21, 2023.

(51) Int. Cl. G01M 7/02; G01H 13/00

(52) U.S. Cl. CPC G01M 7/025; G01H 13/00

(57) ABSTRACT

The present disclosure relates to a system for detecting object resonance caused by vortex shedding as well as deviations from vertical and electrical storm activity and related phenomena: (a) a housing comprising an inside surface and an outside surface, and configured to encapsulate components of the system; (b) a plurality of sensors comprising an accelerometer, a gyroscope, a pressure sensor, an anemometer, a global positioning system, and electrostatic sensors; (c) a control module comprising processor being operatively connected to the plurality of sensors and configurable to: (i) receive signals from the plurality of sensors; (ii) perform an analysis of the signals to determine one of the presence and absence of object resonance caused by vortex shedding and deviations from vertical; (iii) generate at least one result based on the analysis of the signals; and (iv) transmit the result to a user interface device; and (d) a power supply electronically connected to and configured to provide electrical power to each of the plurality of sensors and the processor.

### CROSS-REFERENCE SECTION

This application claims priority to U.S. Provisional Application No. 63/461,187, filed on Apr. 21, 2023, which is incorporated by reference herein in its entirety for all purposes.

### FIELD OF THE DISCLOSURE

The present disclosure relates, according to some embodiments, to systems and methods for detecting oscillations of equipment in a horizontal or vertical plane caused by wind, especially that of vortex shedding.

### BACKGROUND

Vortex shedding is an oscillating flow that takes place when a fluid such as air or water flows past an object (e.g., elevated platform) at certain velocities, depending on the size and shape of the object. In this flow, vortices are created at the back of the object and detach periodically from either side of the body forming a Kármán vortex street. The fluid flow past the object creates alternating low-pressure vortices on the downstream side of the object. The object will tend to move toward the low-pressure zone.

If the object is not mounted rigidly and the frequency of vortex shedding matches the resonance frequency of the object, then the object can begin to resonate, vibrating with harmonic oscillations driven by the energy of the flow. This vibration is the cause for overhead power line wires humming in the wind, and for the fluttering of automobile whip radio antennas at some speeds.

Vortex shedding, once occurring, may lead to significant equipment damage or catastrophic failure. For example, objects that are located on elevated structures may become dislodged or the entire apparatus may collapse or topple over. This unexpected event can be especially dangerous to ground personnel. Early detection of such vortex shedding events could prevent such damage, avoid productivity delays and save lives. Thus far, early detection systems, especially in the agriculture, construction, and film industries, have yet to be developed and are needed. This type of technology can be instrumental in facilitating and backing up early decision making when uncertainty prevails, thus contributing to a safer work environment. Permanent logs of warnings will discourage reckless and dangerous decisions by senior management.

### SUMMARY

The present disclosure relates to a system for detecting object resonance caused by vortex shedding as well as deviations from vertical and horizontal positioning, electrical storm activity, and related phenomena. The system includes a housing containing an inside surface and an outside surface, and is configured to encapsulate components of the system. The system may include a plurality of sensors including an accelerometer, a gyroscope, a pressure sensor, an anemometer, a global positioning system, and electrostatic sensors. The system may include a control module containing a processor being operatively connected to the plurality of sensors and configurable to receive signals from the plurality of sensors and external sources (Internet) and perform an analysis of the signals to determine one of the presence and absence of object resonance caused by vortex shedding. The processor may be configurable to generate at least one result based on analysis of the signals and transmit and log the result to a user interface device. The system may include a power supply electronically connected to and configured to provide electrical power to each of the plurality of sensors and the processor.

The present disclosure further relates to a system for detecting object resonance caused by vortex shedding as well as deviations from vertical and electrical storm activity and related phenomena. The system may include a housing including an inside surface and an outside surface, and configured to encapsulate components of the system. The system may include a sensor attached to one of the inside surface and the outside surface the housing. The sensor may include an accelerometer.

The system may include a control module attached to one of an inside surface and an outside surface of the housing. The control module may include a processor being operatively connected to the plurality of sensors. The control module may be configurable to receive signals from the sensor and external source and perform an analysis of the signals to determine one of the presence and absence of object resonance caused by vortex shedding. The control module may be configurable to generate at least one result based on the analysis of the signals and transmit and log the result to a user interface device. The system may include a power supply attached to one of the inside surface and the outside surface of the housing, the power supply electronically connected to and configured to provide electrical power to the sensor and the processor. The power supply may include a rechargeable battery. The system may further include a wireless induction charger configured to recharge the rechargeable battery of the power supply.

A system according to the present disclosure may include a second sensor attached to one of an inside surface and an outside surface a housing. The second sensor may include one of a gyroscope, a pressure sensor, an anemometer, and an electrostatic sensor. The system may include a second sensor and a third sensor, each attached to one of the inside surface and the outside surface of the housing, and each including one of a gyroscope, a pressure sensor, an anemometer, and an electrostatic sensor. The system may further include each of a gyroscope sensor, a pressure sensor, an anemometer sensor, and an electrostatic sensor. The system may further include a wireless radio connection device attached to one of the inside surface and the outside surface of the housing and configured to send electronic communication to a user interface. The system may further include a global positioning system attached to one of the inside surface and the outside surface of the housing and configured to communicate positional information to a user interface. The system may include an attachment mechanism configured to attach the system to an object so that the system will detect object resonance of the object caused by vortex shedding.

The present disclosure relates to a system for detecting object resonance caused by vortex shedding as well as deviations from vertical and electrical storm activity and related phenomena. The system may include a housing comprising an inside surface and an outside surface, and configured to encapsulate components of the system. The system may include a plurality of sensors attached to one of the inside surface and the outside surface the housing, where the plurality of sensors comprise an accelerometer, a gyroscope, a pressure sensor, an anemometer, and an electrostatic sensor. The plurality of sensors comprises each of the accelerometer, the gyroscope, the pressure sensor, the anemometer, and the electrostatic sensor.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 shows a schematic block diagram of a system for detecting object resonance caused by vortex shedding, according to some embodiments of the disclosure.

FIG. 2 shows a disclosed system attached to a top of a light post, according to some embodiments of the disclosure.

### DETAILED DESCRIPTION

The present disclosure relates to systems and methods for detecting object resonance caused by vortex shedding or periodic gusts of wind, thus leading to unacceptable vibrating and deviations from vertical and horizontal positioning. A disclosed system may provide for early detection of vortex shedding events so that implementation of preventative measures may be undertaken to protect affected objects and workers stationed in proximity to affected objects. The disclosed system may be attached to objects including a telescopic aerial lift, a telehandler, a scissor lift, a crane, a building, or any other elevated structure, and may advantageously provide early detection of vortex shedding events so that the equipment may be repositioned to a safe position, thereby preventing equipment damage, costly repairs and potential injuries.

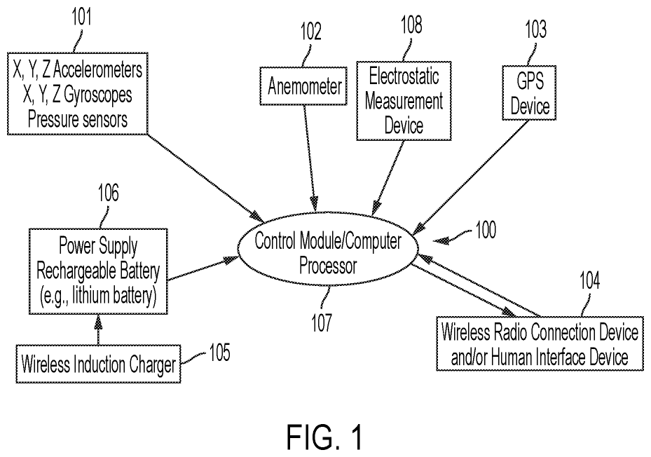

FIG. 1 illustrates a schematic block diagram of a system 100 for detecting object resonance caused by vortex shedding. The system 100 may include accelerometers, gyroscopes, and pressure sensors 101, an anemometer 102, and a global positioning system (GPS) 103. As shown in FIG. 1, the system 100 may include a wireless radio connection and/or human interface device 104, a wireless induction charger 105, a power supply (e.g., rechargeable battery) 106, and a control module 107. Each component of a disclosed system 100 may function together to provide for early detection of vortex shedding events, such as to a user system or server. The system 100 may include a housing having an inside surface and an outside surface, the housing configured to encapsulate and/or support components of the system. Each component may be connected to an inside surface and/or an outside surface of the housing of the system 100.

As shown in FIG. 1, a system 100 may include a plurality of sensors 101 operable to gather data of various types. Each of the sensors 101 may attach to an inside surface and/or an outside surface of a housing for the system 100. For example, any number of sensors may be attached to an inside surface of the housing of the system 100. In some embodiments, any number of sensors may be located on an outside of the housing of the system 100, such as by being attached to an outside surface of the housing. The sensors 101 may include one or more accelerometers configured to measure an acceleration of the system in at least an X, Y, and Z directional axes. In some embodiments, the system 100 may be attached to an object (e.g., crane) so that the system 100 may detect acceleration of the object in at least an X, Y, and Z directional axes. The sensors 101 may include a gyroscope(s) configured to measure orientation of the system 100 or object attached thereto, as well as angular velocity in at least an X, Y, and Z directional axes. The sensors 101 may measure an angular velocity ranging from about 0.01 m/s to about 50 m/s, or higher. For example, the sensors 101 may measure an angular velocity of about 0.01 m/s, or about 1 m/s, or about 5 m/s, or about 10 m/s, or about 15 m/s, or about 20 m/s, or about 25 m/s, or about 30 m/s, or about 35 m/s, or about 40 m/s, or about 45 m/s, or about 50 m/s, where about includes plus or minus 2.5 m/s.

Disclosed systems 100 may include sensors 101 including one or more pressure sensors configured to determine an atmospheric pressure and changes thereof. The system 100 may include a pressure sensor that is for determining the atmospheric pressure felt by the system 100 or an object that the system 100 is attached to. In some embodiments, the disclosed sensor 101 may include a pressure sensor for measuring an air pressure ranging from about 100 mbar to about 1,100 mbar, or higher. For example, the sensor 101 may include a pressure sensor that measures an air pressure of about 100 mbar, or about 300 mbar, or about 500 mbar, or about 700 mbar, or about 900 mbar, or about 1,100 mbar, where about includes plus or minus 100 mbar.

Disclosed sensors 101 may include an electrostatic measurement device 108 for advanced lightning detection. The electrostatic measurement device 108 may measure electrostatic charge on any component of the system 100 or an object the system 100 is attached to, thereby detecting lightning in advance. Analysis of data acquired by the sensors 101,102,103 may be transmitted to a control module 107 containing a processor, and analyzed by the processor to determine one of the presence and absence of object resonance caused by vortex shedding. Detection of the presence of resonance caused by vortex shedding may be used as a warning to move (e.g., lower in height) an object that the system 100 is attached to, to a new location. Moving the object and thereby system 100 to a new location may ensure that the object will be in the absence of unacceptable forces (e.g., winds) that may lead to resonance caused by vortex shedding and damage to the object or system 100. For example, an object and attached system 100 held at a given height by an aerial device may be lowered to a height where the object and attached system 100 experience reduced forces that were leading to resonance caused by vortex shedding.

In some embodiments, a system 100 may include an anemometer 102, as shown in FIG. 1. The anemometer 102 may measure wind speed in any direction (e.g., x, y, and z axes), as felt by the system 100 or an object attached thereto. The anemometer 102 may include a laser Doppler anemometer, an ultrasonic anemometer, an acoustic anemometer, a plate anemometer, a tube anemometer, a Pitot tube static anemometer, a speed vane anemometer, a pressure anemometer, a hot wire anemometer, a cup anemometer, a vane anemometer, a propeller anemometer, and others. Signals from the anemometer 102 may be sent to a control module containing a processor. Analysis of data acquired by the anemometer 102 may be analyzed by a processor to determine one of the presence and absence of wind speed levels that may lead to object resonance, such as object resonance caused by vortex shedding.

A system 100 may include a GPS device 103, which may determine a position of the disclosed system 100, or object attached thereto, as a metric for detecting object resonance caused by vortex shedding. The GPS device 103 may facilitate any combination of detection, generation, modification, analysis, transmission, and presentation of location information of the system 100, or object attached thereto. Location information may include any combination of global positioning system (GPS) coordinates, an internet protocol (IP) address, a media access control (MAC) address, geolocation information, an address, a port number, a zip code, a server number, a proxy name, a proxy number, device information, serial numbers, and the like. In some embodiments, the system 100 may include any one or a combination of various sensors, specifically-purposed hardware elements for enabling the GPS device 103 to acquire, measure, and transform location information. The GPS device 103 may be in electronic communication with a control module 107, which may acquire data from the GPS device, perform an analysis of the data to determine the location of the system 100 and may transmit location data to a user device and/or a server. Locational data and online weather mapping may be combined and analyzed to provide recommendations on upcoming weather events.

As shown in FIG. 1, the system 100 may include the control module 107 comprising a processor. The processor may be operatively connected to any of a plurality of sensors. The control module 107 and the processor may be configurable to: receive signals from the plurality of sensors, perform an analysis of the signals to determine one of the presence and absence of object resonance caused by vortex shedding; generate at least one result based on the analysis of the signals; and transmit the result to a bi-directional user interface device and/or a server. In some embodiments, a control module may trigger rules, warnings, and alarms indicating presence of resonance caused by vortex shedding and other air phenomena. Additional real time Internet data such as weather radar information may be included. The control module 107 may prepare a graphical representation of vertical and/or oscillation patterns experienced by the system 100 or object attached thereto, representing the motion of the system 100 and/or the object. The graphical data and alarms may be transmitted from the control module 107 to be displayed on a remote device and/or human interface device 104. Such a device 104 may be a machine base-mounted, a proprietary hand held device or smart phone app 104, equipped with a combination of display (e.g., LCD screen), haptic and audible warning devices. A control module 107 may include, among other elements, any combination of a processor, a memory, an input/output (I/O), and a communication center. As described in present embodiments, each of the processor, the memory, the I/O, and communication center may include a plurality of respective units, subunits, and/or elements. Furthermore, each of the processor, the memory, the I/O, and the communication center of the control module 107 may be operatively or otherwise communicatively coupled with each other so as to facilitate the methods and techniques described herein.

A processor of the control module 107 may control any one or more of the memory, the I/O, the communication center, or any other unit which may include a server, as well as any included subunits, elements, components, devices, or functions performed by each or a combination of the memory, the I/O, the communication center or any other unit which may include the server. Any of the elements or sub-elements of the server presented here may also be included in a similar fashion in any of the other units, subunits, and devices included in an operating system. Additionally, any actions described herein as being performed by a processor may be taken by the processor alone, or by the processor in conjunction with one or more additional processors, units, subunits, elements, components, devices, and the like. Additionally, while only one processor may be included in disclosed embodiments, multiple processors may be present or otherwise included in the control module 107. Thus, while instructions may be described as being executed by the processor or the various subunits of the processor, the instructions may be executed simultaneously, serially, or otherwise by one or more multiple processors.

In some embodiments, a processor of the control module 107 may be implemented as one or more computer processor (CPU) chips, graphical processor (GPU) chips, or some combination of CPU chips and GPU chips, and may include a hardware device capable of executing computer instructions. The processor may execute any combination of instructions, codes, computer programs, and scripts. The instructions, codes, computer programs, and scripts may be received from, stored in, or received from and stored in any combination of the memory, the I/O, the communication center, subunits of the previously described elements, other devices, or other computing environments.

As shown in FIG. 1, the system 100 may include a wireless radio connection device and/or human interface device 104, which may connect to a wireless communications network. In some embodiments, a wireless communications network may include a 3G network, 4G, LTE, 5G, Wi-Fi, Bluetooth, or any other network protocol and may be a combination of any number of networks. In some embodiments, a system may include a wired network connection such as a conventional Ethernet connection, such as with a personal computer with an Ethernet port.

In some embodiments, as shown in FIG. 1, the system 100 may include a power supply 106. The power supply 106 may be configured to provide electrical power to any component of the disclosed system 100. For example, the power supply 106 may be electronically connected to and configured to provide electrical power to each of the plurality of sensors 101, the anemometer 102, the GPS device 103, the wireless radio connection device and/or human interface device 104, the control module 107, and a processor contained within the control module 107. The power supply may include a battery, such as a rechargeable battery. The battery may include a lead-acid battery, a nickel-cadmium battery, a nickel-iron battery, a nickel-metal hydride battery, a lithium-ion battery, a lithium-ion polymer battery, others, and combinations thereof.

As shown in FIG. 1, the system 100 for detecting object resonance caused by vortex shedding may include a wireless induction charger 105. The wireless induction charger 105, through electromagnetic induction may charge a power supply 106 of the system 100.

The system 100 may include a housing (not pictured), which may include an inside surface and an outside surface. The housing may be configured to encapsulate components of the system, thereby protecting it from the elements (e.g., sunlight, wind, rain). The housing may encapsulate sensors 101, anemometer 102, GPS device 103, wireless radio connection device and/or human interface device 104, power supply 106, control module 107, wireless induction charger 105, and more. In some embodiments, wireless induction charger 105 is located outside of the housing. The housing can be made of any known metal (e.g., steel) or polymer (e.g., high density polyethylene). For example, the housing may be made of a metal including a steel, a titanium, a brass, a copper, a lead, an iron, a bronze, an aluminum, a carbon steel, mixtures thereof, and alloys thereof. The housing may be made of a polymer including a polyethylene, a polystyrene, a polyurethane, a nylon, a polypropylene, a polyethylene terephthalate, a polymethylmethacrylate, a polyacrylonitrile, a polyvinyl chloride, a polycarbonate, a silicone, a polyester, mixtures thereof, and copolymers thereof. The housing may be of any general shape, including a cube, a cuboid, a cylinder, a sphere, a cone, a pyramid, a torus, a hemisphere, a polyhedron, a triangular prism, a pentagonal prism, a hexagonal prism, mixtures thereof, and other. The housing may have any general size, such as having at least one dimension (e.g., length, width, height, diameter, etc.) that is about 1 inch, or about 2 inches, or about 3 inches, or about 4 inches, or about 5 inches, or about 6 inches, or about 7 inches, or about 8 inches, or about 9 inches, or about 10 inches, or about 11 inches, or about 12 inches, or more, where about includes plus or minus 1 inch. For example, a housing may have a cube shape, a height of about 4 inches, a length of about 4 inches, an da width of about 4 inches.

In some embodiments, a system 100 for detecting object resonance caused by a vortex shedding may include a radio frequency identification (RFID) tag used to uniquely identify the type of system 100 and may be fitted to a bracket on said system 100. The RFID tag reader may be located on the inside or outside of a housing of the system 100. The RFID tag reader may provide a means for the processing system to identify the type of system 100 and select the correct algorithms to sort user data and presets for any given object/system 100 combination. The RFID system may provide a means to track permanent memory of a given object for accident analysis and auditing purposes.

According to some embodiments, the present disclosure relates to a system 100 for detecting object resonance caused by vortex shedding. A housing of the system 100 may be configured to attach to a surface of an object, so that the system 100 for detecting object resonance caused by vortex shedding may determine the presence or absence of object resonance caused by vortex shedding for the object. The system 100 may be attached to any number of objects including, but not limited to, a telescopic aerial lift, a telehandler, a light post, a scissor lift, a crane or any other elevated structure. The system 100 may be attached to the object by any known means, including an adhesive, a weld, a bolt, a screw, a tie, or any other known method. For example, an outside surface of a house of the system 100 may be attached to an outside surface of an object through an adhesive. In some embodiments, the system 100 may be compartmentalized within part of the object.

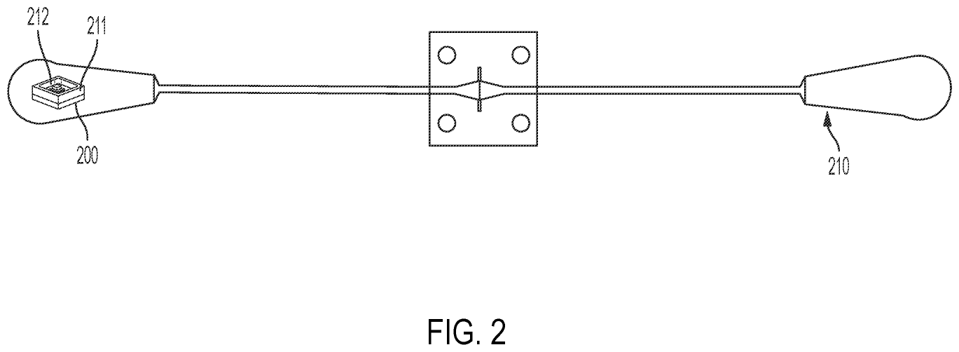

FIG. 2 shows a disclosed system 200 attached to a top of an object. As shown in FIG. 2, the object may include a light post 210. FIG. 2 also shows an outside surface 211 and inside surface 212 of a housing of the system 200. A top of the housing of system 200 in FIG. 2 has been cut away so that the inside surface 212 is viewable. In some embodiments, the disclosed system 200 is substantially fully covered to protect components found inside. The object in FIG. 2 is a light post 210, but any object may be used, including, but not limited to, a telescopic aerial lift, a telehandler, a scissor lift, a crane, a building, or any other elevated structure.

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A system for detecting object resonance caused by vortex shedding, the system comprising:
(a) a housing comprising an inside surface and an outside surface, and configured to encapsulate components of the system; and
(b) a sensor attached to one of the inside surface and the outside surface of the housing, the sensor comprising an accelerometer.

2. The system according to claim 1, further comprising:
a control module attached to one of the inside surface and the outside surface of the housing, the control module comprising a processor being operatively connected to the plurality of sensors.

3. The system according to claim 2, wherein the control module is configurable to:
(i) receive signals from the sensor and external source;
(ii) perform an analysis of the signals to determine one of the presence and absence of object resonance caused by vortex shedding;
(iii) generate at least one result based on the analysis of the signals; and
(iv) transmit and log the result to a user interface device.

4. The system according to claim 2, further comprising:
a power supply attached to one of the inside surface and the outside surface of the housing, the power supply electronically connected to and configured to provide electrical power to the sensor and the processor.

5. The system according to claim 4,
wherein the power supply comprises a rechargeable battery, and
wherein the system further comprises a wireless induction charger configured to recharge the rechargeable battery of the power supply.

6. The system according to claim 1, further comprising a second sensor attached to one of the inside surface and the outside surface the housing, the second sensor comprising at least one of a gyroscope, a pressure sensor, an anemometer, and an electrostatic sensor.

7. The system according to claim 1, further comprising a second sensor and a third sensor, each attached to one of the inside surface and the outside surface of the housing, the second sensor and third sensor each comprising one of a gyroscope, a pressure sensor, an anemometer, and an electrostatic sensor.

8. The system according to claim 1, further comprising a gyroscope sensor, a pressure sensor, an anemometer sensor, and an electrostatic sensor.

9. The system according to claim 1, further comprising at least one of:
a wireless radio connection device attached to one of the inside surface and the outside surface of the housing and configured to send electronic communication to a user interface; and
a global positioning system attached to one of the inside surface and the outside surface of the housing and configured to communicate positional information to a user interface.

10. The system according to claim 1, further comprising an attachment mechanism configured to attach the system to an object so that the system will detect object resonance of the object caused by vortex shedding.

11. A system for detecting object resonance caused by vortex shedding, the system comprising:
(a) a housing comprising an inside surface and an outside surface, and configured to encapsulate components of the system; and
(b) a plurality of sensors attached to one of the inside surface and the outside surface of the housing, the plurality of sensors comprising an accelerometer, a gyroscope, a pressure sensor, an anemometer, and an electrostatic sensor.

12. The system according to claim 11, further comprising:
a control module attached to one of the inside surface and the outside surface of the housing, the control module comprising a processor being operatively connected to the plurality of sensors.

13. The system according to claim 12, wherein the control module is configurable to:
(i) receive signals from the plurality of sensors and external sources.
(ii) perform an analysis of the signals to determine one of the presence and absence of object resonance caused by vortex shedding;
(iii) generate at least one result based on the analysis of the signals; and
(iv) transmit and log the result to a user interface device.

14. The system according to claim 12, further comprising:
a power supply attached to one of the inside surface and the outside surface of the housing, the power supply electronically connected to and configured to provide electrical power to each of the plurality of sensors and the processor.

15. The system according to claim 14,
wherein the power supply comprises a rechargeable battery, and
wherein the system further comprises a wireless induction charger configured to recharge the rechargeable battery of the power supply.

16. The system according to claim 11, further comprising:
a wireless radio connection device attached to one of the inside surface and the outside surface of the housing and configured to send electronic communication to a user interface.

17. The system according to claim 11, further comprising:
a global positioning system attached to one of the inside surface and the outside surface of the housing and configured to communicate positional information to a user interface.

18. The system according to claim 11, further comprising an attachment mechanism configured to attach the system to an object.

19. The system according to claim 18, wherein the system is configured to detect object resonance of the object caused by vortex shedding.
